(19) United States
(12) Patent Application Publication
(10) Pub. No.: US 2004/0183364 A1
(43) Pub. Date: Sep. 23, 2004

(54) Miniaturized dash valve system

(75) Inventors: Andy Marsh, Elyria, OH (US); John Kemer, Avon Lake, OH (US); Jim Szudy, Parma, OH (US); Dave Goodell, Beaverton, OR (US)

Correspondence Address: CALFEE, HALTER & GRISWOLD, LLP, 1110 FIFTH THIRD CENTER, 21 EAST STATE STREET, COLUMBUS, OH, 43215-4243, US

(73) Assignee: Bendix Commercial Vehicle Systems LLC, Elyria, OH

(21) Appl. No.: 10/747,539

(22) Filed: Dec. 29, 2003

Related U.S. Application Data
(60) Provisional application No. 60/437,418, filed on Dec. 31, 2002.

(51) Int. Cl. B60T 13/00

(52) U.S. Cl. 303/7

(57) ABSTRACT

A system for controlling the pneumatic brakes of a vehicle that has both a tractor portion and/or a trailer portion. This system includes a first brake module for applying or releasing the pneumatic brakes (i.e., parking brakes and service brakes) located on the tractor portion of the vehicle, a second brake module connected to the first brake module for applying or releasing the pneumatic brakes (i.e., parking brakes and service brakes) located on the trailer portion of the vehicle, a dash-mounted parking brake control module connected to the first brake control module and the second brake control module for controlling the function of the first and second brake modules relative to the parking brakes, and least one source of compressed air in communication with the system for supplying pressurized air to the various modules. A similar system for controlling the pneumatic brakes of a vehicle having only a tractor portion is also provided.

### CROSS-REFERENCE TO RELATED APPLICATIONS

This patent application claims the benefit of U.S. Provisional Patent Application Serial No. 60/437,418 filed on Dec. 31, 2002 and entitled “Miniature Dash Valve System for Trucks and Tractors,” the disclosure of which is incorporated as if fully rewritten herein.

### STATEMENT REGARDING FEDERALLY FUNDED RESEARCH

This invention was not made by an agency of the United States Government nor under contract with an agency of the United States Government.

### TECHNICAL FIELD OF THE INVENTION

The present invention relates generally to air brake systems for large commercial and/or industrial vehicles, and more specifically to a modular system for separating air-brake system components that are typically integrated, thereby allowing certain aspects of the system to be relocated and/or miniaturized.

### BACKGROUND OF THE INVENTION

Air brake systems installed on large vehicles typically utilize compressed air to operate the brakes of the vehicle. Prior art air brake systems usually include a combination of three different braking systems, namely: the service brakes, the parking brakes, and the emergency brakes. The service brake system applies and releases the brakes when the driver uses the brake pedal during normal driving situations. The parking brake system applies and releases the parking brakes when the parking brake control is actuated. The emergency brake system utilizes portions of the service brake and parking brake systems to stop the vehicle in the event of a brake system failure.

The air brake systems installed on large commercial vehicles such as trucks, tractor/trailer rigs, and buses typically utilize mechanically operated pneumatic push-pull control valves for actuation and release of the vehicle's parking brakes and control of the supply line to the trailer service brakes. Federal Motor Vehicle Safety Standard (FMVSS) No. 121 requires that these parking brake controls and the trailer brake controls be located in close proximity to the operator of the vehicle.

Given the current state of the art, compliance with this rule necessitates the installation of large pneumatic push-pull valves, such as the commercially available MV-3 valve, in the vehicle's instrument panel. The required pneumatic lines and connectors must also be placed directly within the instrument panel. Thus, the standard configuration of system components results in a large assembly that is bulky and that reduces available space in the instrument panel. Furthermore, this arrangement of components often imposes design parameters that are detrimental to the comfort and convenience of the driver. Thus, there is a need for a system that improves the overall design of the vehicle's instrument panel and that enhances driver ergonomics while still allowing for compliance with FMVSS No. 121.

### SUMMARY OF THE INVENTION

These and other disadvantages of the prior art are overcome by the present invention which provides an improved design for configuring the system that controls the air brakes of a large commercial vehicle. This system includes non-integrated or separate modules for controlling the brake system of a vehicle when that vehicle (i) is operating in truck mode, i.e., not pulling a trailer (the “truck application”) or (ii) is operating in tractor mode, i.e., is pulling a trailer (the “tractor application.”)

Thus, a first exemplary embodiment provides a system for controlling the pneumatic brakes of a vehicle that has both a tractor portion and a trailer portion. This system includes a first brake module for applying or releasing the pneumatic brakes (i.e., parking brakes and service brakes) located on the tractor portion of the vehicle, a second brake module connected to the first brake module for applying or releasing the pneumatic brakes (i.e., parking brakes and service brakes) located on the trailer portion of the vehicle, a dash-mounted parking brake control module connected to the first brake control module and the second brake control module for controlling the function of the first and second brake modules relative to the parking brakes, and least one source of compressed air in communication with the system for supplying pressurized air to the various modules.

A second exemplary embodiment provides a system for controlling the pneumatic brakes of a vehicle having only a tractor portion, thus operating as a truck. This system includes a brake control module for applying or releasing the pneumatic brakes (i.e., parking brakes and service brakes) located on the truck portion of the vehicle, a dash-mounted parking brake control valve connected to the brake control module for controlling the function of the brake control module relative to the parking brakes, and at least one source of compressed air in communication with the system for supplying pressurized air to the brake control module and the parking brake control valve.

The overall configuration of the system shown in the Figures allows the tractor module to be mounted on the dash or control panel, and allows the trailer brake module to be mounted elsewhere such as, for example, on the exterior of the vehicle or at another location. The result is greater flexibility in the placement and mounting of the separate modules as compared to more conventional integrated, combined brake systems. Furthermore, the vehicle's dashboard layout and configuration is simplified by use of smaller valves and pneumatic lines while still maintaining flow capacity and functionality to meet all applicable US DOT regulations. Also, dashboard styling and flexibility is significantly enhanced by the use of smaller components in general.

Further advantages of the present invention will become apparent to those of ordinary skill in the art upon reading and understanding the following detailed description of the preferred embodiments.

### BRIEF DESCRIPTION OF THE DRAWINGS

The accompanying drawings, which are incorporated into and form a part of the specification, schematically illustrate one or more exemplary embodiments of the invention and, together with the general description given above and detailed description of the exemplary embodiments given below, serve to explain the principles of the invention.

FIG. 1 is a schematic view of a conventional prior art air brake system configured for the truck application.

FIG. 2 is a schematic representation of a prior art vehicle braking system utilizing the current, commercially available system configured for the tractor application.

FIG. 3 is a schematic representation of an exemplary embodiment of modular brake system of the present invention configured for the tractor/trailer application.

FIG. 4 is a schematic representation of an exemplary embodiment of modular brake system of the present invention configured for the truck application.

### DETAILED DESCRIPTION OF THE INVENTION

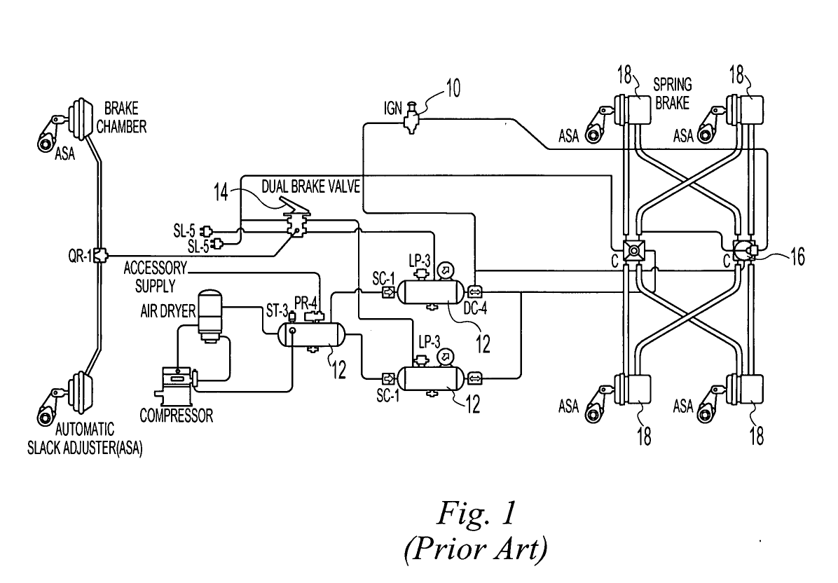

For the purpose of providing context for the present invention, FIG. 1 presents a schematic representation of a conventional prior art air brake system configured for the truck application (from U.S. Pat. No. 6,322,159 to Eberling). In this system, control of the vehicle's parking brakes is provided by a parking control valve 10 which is a single-button push-pull mechanical, pneumatic valve that both applies line pressure in a first position and exhausts the line pressure that is applying the parking brakes in a second position. Air pressure from reservoir 12 flows through valve 10 and through a spring brake relay valve 16 to release spring brakes 18, thereby allowing normal movement of the vehicle. Upon actuation of valve 10, the line to spring brake 18 is vented and the spring brake activates the parking brake. Normal service braking may be accomplished by using a pedal mounted service brake valve 14 which, when actuated, supplies air from the service reservoirs to the front and rear service chambers of the brake portion of the spring brake actuator.

The double check valve (DC-4), supplies both the parking brake control valve 10 and the spring brake relay valve 16 (note: although not shown, a spring brake control valve is also typically part of the circuit). When the parking brake control valve button is pushed in, the valve delivers pressure to the control part of the spring brake relay valve. This opens the reservoir supply to the spring brake actuators through the relay valve. When the button is pulled, valve 10 exhausts the pressure on top of the relay valve piston and the relay valve exhausts the pressure from the spring brake actuators. The line from the service brake relay valve to the spring brake relay valve provides the anti-compounding function. The push-pull valve activates the spring brake relay valve 16 when both service reservoirs fail. The valve plunger is pushed out by spring force, thereby releasing air pressure to the spring brake relay, which releases the air pressure that is keeping the spring brakes released. This actuates the spring brakes.

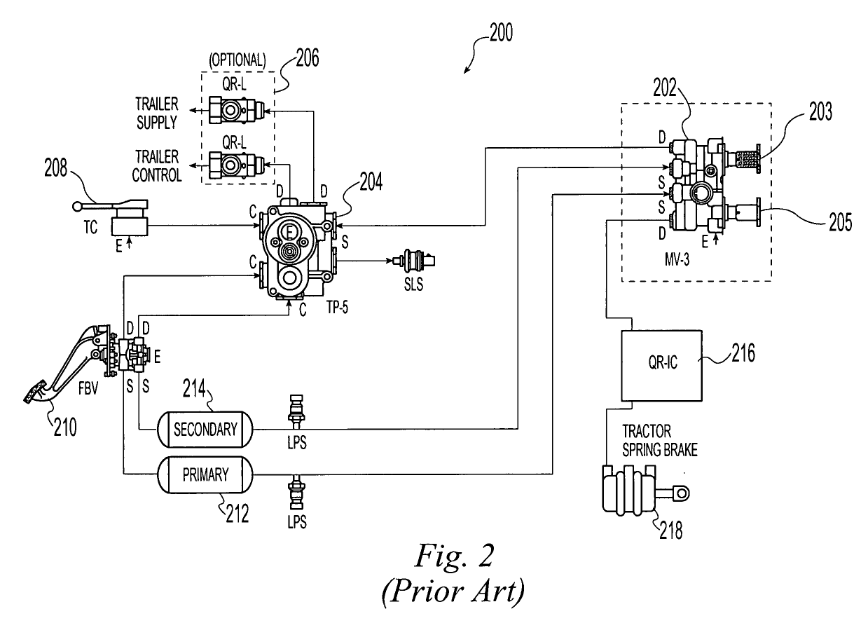

Also for the purpose of providing context for the present invention, FIG. 2 includes a schematic representation of a vehicle braking system utilizing the current, commercially available MV-3™/ TP-5™(commercially available from Bendix Commercial Vehicle Systems LLC, Elyria, Ohio) system configured for the tractor application. Both primary and secondary reservoirs 212 and 214 supply the MV-3™ valve 202. There are two separate manually operated valves in the MV-3 that are capable of applying line pressure in a first position and exhausting the line pressure that would apply the parking brakes in a second position. The valve also contains a double check valve that prioritizes reservoir pressure being supplied to the manual valves. This internal double check valve feeds both the parking control valve and the trailer supply valve.

When trailer supply button 203 (red button) is pushed in, the MV-3 TM valve 202 delivers pressurized air to the TP-5™ valve 204 opening the path for any service brake application by means of brake pedal 210 to modulate the trailer service brakes from the control line. The TP-5™ valve 204 delivers pressure to the trailer supply line through the QR-L (quick release valve) 206, that then delivers the pressure to release the parking brakes. When the parking control button 205 (yellow button) is pushed in, the MV-3™ valve 202 delivers pressurized air to the tractor spring brakes 218 by way of the QR-1C 216 (or two quick release valves or a spring brake relay valve depending on the number of spring brake actuators). When the parking control button is pulled out, the trailer supply button also comes out and the air to the trailer supply line is exhausted thereby applying the spring brakes on the trailer. The air to the tractor quick release valve is exhausted and the quick release valve exhausts the pressure from the spring brakes therefore applying the tractor parking brakes.

The parking control button 205 (yellow button) will actuate the trailer supply button 203 (red button-trailer parking brakes) into its brake-apply position; however, the red button will not actuate the yellow button. The delivery of the parking control air supplies the QR-1C (Quick Release/Double Check Valve) 216, which in turn delivers and exhausts pressure to the spring brake section of the spring brake 218.

As previously stated, the present invention reduces of the size of the parking brake system components that are typically mounted in a vehicle's dashboard. The exemplary embodiment of the system is non-integrated, i.e., separate pneumatic modules control the air brake system of a vehicle when that vehicle (i) is operating in truck mode, i.e., not pulling a trailer, or (ii) is operating in tractor mode, i.e., is pulling a trailer. This system is intended to replace or serve as a substitute for the system of FIG. 1 as well as the pneumatic valve system of FIG. 2.

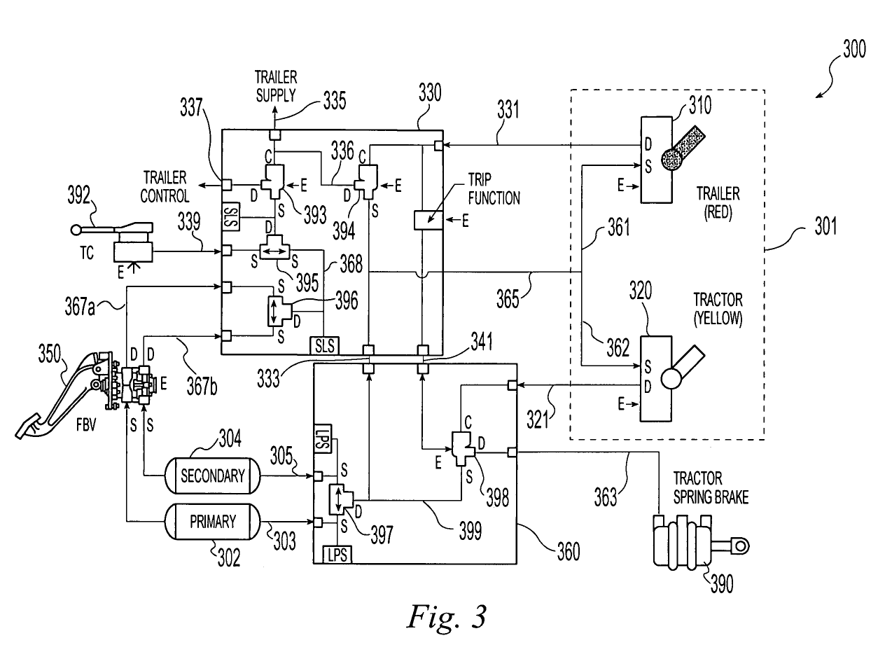

As shown in FIG. 3, an exemplary embodiment of air brake system 300, which is configured for the “tractor” application includes trailer brake module 330 which is typically mounted on the back of the vehicle's cab or on the firewall, truck/tractor brake module 360 which may also be mounted on the firewall or on a tractor frame rail, and a parking brake control module 301 which is typically located inside the cab on the vehicle's instrumental panel. Trailer dash valve 310 and tractor dash valve 320 are the primary components of parking brake control module 301, which is used by the driver to control the parking brakes of the vehicle. In the exemplary embodiment, each one of these valves is relatively small in size and includes a supply port, a delivery port, and an exhaust port. These valves are capable of changing state in response to certain predetermined air pressures and/or they are capable of a indicating a change in state in response to certain predetermined air pressures. In the exemplary embodiment, the miniature dash valves retain the required “pop” function currently present on the current MV-3 pneumatic valve.

Valves 310 and 320 replicate the function of the push-pull buttons on the currently used MV-3 valve assembly. Valve 310 includes a red switch that when actuated, controls the spring brakes on the trailer. Valve 320 includes a yellow switch that when actuated, controls the spring brakes on the tractor. Per federal regulations, the yellow switch when actuated, also controls the brakes on the trailer. Both valves 310 and 320 receive pressurized air at their supply ports from line 365 which splits into line 361 to supply dash valve 310 and line 362 to supply dash valve 320. Line 331 delivers pressurized air from dash valve 310 to trailer brake module 330 and line 321 delivers pressurized air from dash valve 320 to truck/tractor module 360.

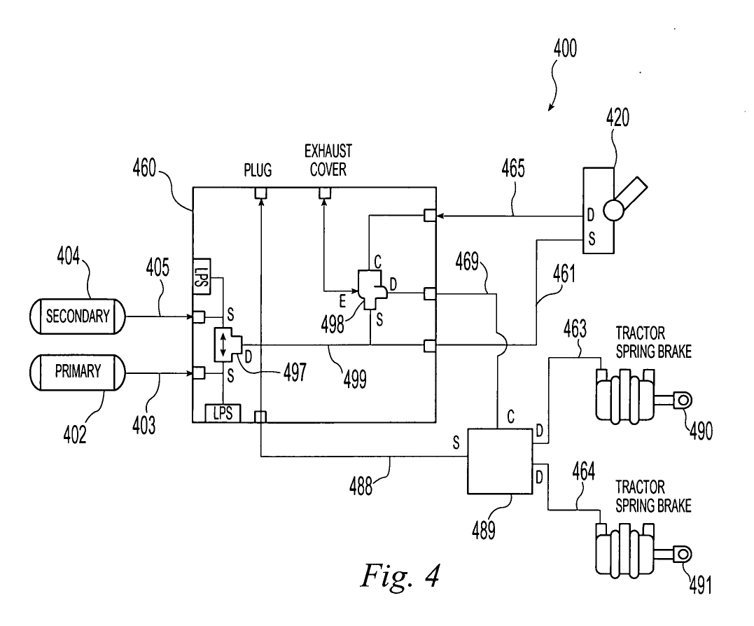

With reference to FIGS. 3 and 4 and the exemplary embodiments shown therein, trailer brake module 330 includes two internal double check valves 395 and 396 as well as two internal on/off control valves 393 and 394 (also known in the art as “synchro-valves”). Truck/tractor control module 360 includes a single internal double check valve 397 and a single control valve 398. Generally speaking, these valves are double check valves and on/off, pilot operated, non-graduating control valves that provide the logic to meet the US DOT requirements and provide apply and release capacity while installed in a location outside of the instrument panel, thereby providing for instrument panel design flexibility. The double check valves are valves that selectively deliver the higher of two air pressures to the supply ports of the on/off control valves. As pressure builds in the control lines leading into an on/off control valve, this valves closes the exhaust port and opens the supply pathway to the delivery port. When pressure in the control line drops, the on/off control valves close the supply pathway and open the pathway to the exhaust port.

Both brake modules also include a series of external ports (shown in the Figures as small boxes at the perimeter of the modules) for allowing the modules to receive air lines and communicate with peripheral devices such as the service brake pedal and trailer control valve. Both brake modules include a plurality of internal pneumatic lines linking the various internal valves and providing the communicative pathways between the system components. It should be noted that the various valves and modules shown in the Figures include the following designations: “c” which refers to “control,” “d” which refers to “delivery,” “e” which refers to “exhaust,” “s” which refers to “supply,” “LS” which refers to “stop light switch,” “LPS” which refers to “low pressure switch,” and “FBV” which refers to “foot brake valve.”

As shown in FIG. 3, truck/tractor brake module 360 receives pressurized air from dash valve 320 through line 321, which may be small in size due to its control nature. When control valve 398 receives this pressurized air at its control port, it opens the supply port to receive pressurized air from line 399 which is in communication with double check valve 397. Double check valve 397 is also in communication with primary air reservoir 302 by way of line 303 and secondary air reservoir 304 by way of line 305. Double check valve 397 is also in communication with two low pressure switches, each of which is intended to warn the driver when one or both of the main circuits has failed. After control valve 398 has opened the supply pathway to the delivery port, pressurized air travels through line 363 to tractor spring brake assembly 390 and the tractor parking brakes are released. Exhausting the pressurized air from this circuit activates the spring brakes.

Also shown in FIG. 3 is trailer brake module 330. This module replaces the TP-5™ valve discussed above and shown in FIG. 2. Trailer brake module 330, and control valve 394 in particular, receives pressurized air from dash valve 310 through line 331 (which may be small in size due to its control nature) and from line 341 which is in communication with the exhaust port of control valve 398. The trip function allows the pressure release of both the parking control and the trailer supply circuits when only the parking control switch is actuated to the apply position. Control valve 394 is supplied with pressurized air by line 333 which is in communication with double check valve 397. Upon receiving the appropriate signal from dash valve 310, control valve 394 delivers pressurized air through line 336 to (i) the control port of control valve 393, and (ii) line 335 which is in communication the trailer supply line which supplies pressurized air to the trailer's spring brakes.

Control valve 394 is set to meet the federal requirement that the trailer supply automatically stops air flow to the trailer if the reservoir on the tractor drops to between 45-20 psi, and this valve also prevents the manual override of the automatic emergency operation. This pressure also opens the second control valve which delivers to the trailer control any apply made by the foot valve or the hand control valve 392 in the tractor. This valve also will shut off the flow of air if there is a trailer breakaway and the saving of tractor air is necessary.

Foot brake valve, or brake pedal 350 receives pressurized air from both the primary and secondary air reservoirs. Upon actuation, brake pedal 350 delivers pressurized air to trailer brake module 330 and to the supply ports of double check valve 396 in particular, through line 367a or 367b. Double check valve 396 is in communication with a stop light switch or with another double check valve 395 by way of line 368. Double check valve 395 receives pressurized air from either double check valve 396 through line 368 or trailer control valve 392 through line 339. Trailer control valve 392 provides a means by which the driver can provide braking and lateral stability to the trailer if the vehicle is rapidly traveling a downgrade. Double check valve 395 delivers pressurized air to either a stop light switch or to the supply port of control valve 393, while control valve 393 delivers pressurized air to trailer control line 337 for controlling the trailer service brakes.

FIG. 4 illustrates an exemplary embodiment of the present invention that has been configured for the “truck” application, i.e., the tractor is not pulling a trailer and is thus operating solely as a truck. In this version of brake system 400, dash valve 420 is the only active miniature valve present in the vehicle's instrument panel. Truck brake module 460 is mounted at a location remote from the dash valve such as the firewall or on a tractor frame rail. Primary air reservoir 402 and secondary air reservoir 404 are in communication with truck brake module 460 by way of lines 403 and 405 respectively, and these supply lines are in communication with double check valve 497 or with one of two low pressure switches which function as previously described. Line 499 is in communication with the supply port of on/off control valve 498 and with the supply port of dash valve 420.

When dash valve 420 is actuated, line 465 delivers pressurized air to the control port of control valve 498 thereby opening the internal passage that allows the supply air to be directed through the delivery port of control valve 498 and into line 469. Line 469 is in communication with spring brake relay valve 489, which receives pressurized supply air through line 488 which is in communication with line 499. Upon receiving the appropriate air pressure at its control port, spring brake relay valve 489 opens the internal passageway that allows the pressurized supply air to be delivered to the tractor/truck spring brake assemblies 490 and 491 by way of lines 463 and 464 respectively.

Both of the embodiments shown in FIGS. 3 and 4 and described herein provide a system and method by which critical dashboard and instrument panel space may be conserved while cab access to the pneumatic parking brake system is maintained. As previously stated, the modular design of this system, coupled with the miniaturization of certain key components, results in a space efficient system that may be used to replace the currently used prior art systems.

While the above description contains much specificity, this should not be construed as a limitation on the scope of the invention, but rather as an exemplification of certain exemplary or preferred embodiments. Numerous other variations of the present invention are possible, and is not intended herein to mention all of the possible equivalent forms or ramifications of this invention. Various changes may be made to the present invention without departing from the scope or spirit of the invention.

What is claimed:

1) A system for controlling the pneumatic brakes of a vehicle, comprising:
(a) a first brake control module, said first module further comprising at least one internal control valve, at least one internal double-check valve, and a plurality of pneumatic lines for connecting said internal valves to one another and to other system components;
(b) a second brake control module in communication with said first brake control module, said second module further comprising at least one internal control valve, at least one internal double-check valve, and a plurality of pneumatic lines for connecting said internal valves to one another and to other system components;
(c) a parking brake control module in communication with said first and second brake control modules, said parking brake control module further comprising at least one miniaturized valve for controlling said pneumatic brakes; and
(d) at least one source of compressed air in communication with said first brake control module, said second brake control module, and said parking brake control module.

2) The system of claim 1, further comprising a foot brake valve connected to said first brake control module and said second brake control module.

3) The system of claim 1, further comprising a trailer control valve in communication with said second brake control module.

4) The system of claim 1, wherein said pneumatic brakes further comprise at least one spring brake assembly in communication with said first brake control module and at least one spring brake assembly in communication with said second brake control module.

5) The system of claim 1, wherein said first brake control module is mounted on the cab of said vehicle, on the firewall of said vehicle, or at another location separate from the other two modules; said second brake control module is mounted on the firewall of said vehicle, on a tractor frame rail, or at another location separate from the other two modules; and said parking brake control module is mounted on the vehicle's dashboard, instrument panel, or at another location in close proximity to the driver of said vehicle.

6) A system for controlling the pneumatic brakes of a vehicle having a tractor portion and a trailer portion, comprising;
(a) a first brake control module for controlling the pneumatic brakes located on said tractor portion of said vehicle, and wherein said pneumatic brakes further comprise parking brakes and service brakes;
(b) a second brake control module connected to said first brake module for controlling the pneumatic brakes located on said trailer portion of said vehicle, and wherein said pneumatic brakes further comprise parking brakes and service brakes;
(c) a parking brake control module connected to said first brake control module and said second brake control module for controlling the function of said first and second brake modules relative to said parking brakes; and
(d) at least one source of compressed air in communication with said system for supplying pressurized air to said first brake control module, said second brake control module, and said parking brake control module.

7) The system of claim 6, further comprising a foot brake valve connected to said first brake control module and said second brake control module for controlling the function of said modules relative to said service brakes.

8) The system of claim 6, further comprising a trailer control valve in communication with said second brake control module.

9) The system of claim 6, wherein said pneumatic brakes further comprise at least one spring brake assembly in communication with said first brake control module and at least one spring brake assembly in communication with said second brake control module.

10) The system of claim 6, wherein said parking brake control module further comprises a first miniature valve for controlling the parking brakes of said trailer and a second miniature valve for controlling the parking brakes for said tractor.

11) The system of claim 10, wherein said first brake control module further comprises at least one internal control valve in communication with said second miniature control valve for controlling the flow of pressurized air from the source of said pressurized air to the parking brakes of said tractor.

12) The system of claim 10, wherein said second brake module further comprises a first internal control valve in communication with said first miniature control valve for receiving pressurized air from the source of pressurized air and the first brake control module, and a second internal control valve in communication with said first internal control valve for controlling the flow of pressurized air to the parking brakes of said trailer.

13) The system of claim 6, wherein said first and second brake control modules further comprise at least one internal double check valve for regulating the flow of pressurized air between multiple sources of pressurized air.

14) The system of claim 6, wherein said first brake control module is mounted on the cab of said vehicle, on the firewall of said vehicle, or at another location separate from the other two modules; said second brake control module is mounted on the firewall of said vehicle, on a tractor frame rail, or at another location separate from the other two modules; and said parking brake control module is mounted on the vehicle's dashboard, instrument panel, or at another location in close proximity to the driver of said vehicle.

15) A system for controlling the pneumatic brakes of a vehicle having truck portion, comprising;
(a) a brake control module for applying or releasing the pneumatic brakes located on said truck portion of said vehicle, and wherein said pneumatic brakes further comprise parking brakes and service brakes;
(b) a parking brake control valve connected to said brake control module for controlling the function of said brake control module relative to said parking brakes; and
(c) at least one source of compressed air in communication with said system for supplying pressurized air to said brake control module and said parking brake control valve.

16) The system of claim 15, wherein said pneumatic brakes further comprise at least two spring brake assemblies, and wherein said at least two spring brake assemblies are in communication with a spring brake relay valve that is in communication with said brake control module.

17) The system of claim 15, wherein said parking brake control valve further comprises a miniature valve for controlling the parking brakes of said truck.

18) The system of claim 15, wherein said brake control module further comprises at least one internal control valve in communication with said parking brake control valve for controlling the flow of pressurized air from the source of said pressurized air to the parking brakes of said truck.

19) The system of claim 18, wherein said brake control module further comprises at least one internal double check valve for regulating the flow of pressurized air between multiple sources of pressurized air.

20) A method for controlling the pneumatic brake system of a vehicle having a tractor portion and a trailer portion, comprising the step of dividing the brake system components into individual modules, wherein said individual modules further comprise:
(a) ) a first brake control module for controlling the pneumatic brakes located on said tractor portion of said vehicle;
(b) a second brake control module connected to said first brake module for controlling the pneumatic brakes located on said trailer portion of said vehicle; and
(c) a parking brake control module connected to said first brake control module and said second brake control module for controlling the function of said first and second brake modules.

21) The method of claim 20, further comprising the step of mounting said first brake control module on the cab of said vehicle, on the firewall of said vehicle, or at another location separate from the remaining control modules.

22) The method of claim 20, further comprising the step of mounting said second brake control module on the firewall of said vehicle, on a tractor frame rail, or at another location separate from the remaining control modules.

23) The method of claim 20, further comprising the step of mounting said parking brake control module on the vehicle's dashboard, instrument panel, or at another location in close proximity to the driver of said vehicle.

24) The method of claim 20, further comprising the step of providing at least one source of pressurized air to said system components.

25) A method for controlling the pneumatic brake system of a vehicle having a tractor portion, comprising the step of dividing the brake system components into individual modules, wherein said individual modules further comprise:
(a) a brake control module for controlling the pneumatic brakes located on said truck portion of said vehicle; and
(b) a parking brake control valve connected to said brake control module for controlling the function of said brake control module.

26) The method of claim 25, further comprising the step of mounting said brake control module on the firewall of said vehicle, on a tractor frame rail, or at another location separate from the parking brake control valve.

27) The method of claim 25, further comprising the step of mounting said parking brake control valve on the vehicle's dashboard, instrument panel, or at another location in close proximity to the driver of said vehicle.

28) The method of claim 25, further comprising the step of providing at least one source of pressurized air to said system components.
